(19) United States
(12) Patent Application Publication
(10) Pub. No.: US 2006/0188102 A1
(43) Pub. Date: Aug. 24, 2006

(54) BTSC encoding method with digital FM modulation

(76) Inventors: Luciano Zoso, Chandler, AZ (US); Allan P. Chin, Phoenix, AZ (US); David P. Lester, Phoenix, AZ (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/060,993

(22) Filed: Feb. 18, 2005

(51) Int. Cl. H04H 5/00

(52) U.S. Cl. 381/2; 381/6; 381/14

(57) ABSTRACT

A method of digital BTSC (Broadcast Television Systems Committee) encoding featuring integrated digital FM modulation comprises digitally encoding and FM modulating. A left audio input signal (64) and a right audio input signal (66) are digitally encoded into a digital composite audio signal (79) via a digital BTSC audio processor (78). Responsive to the digital composite audio signal (79), a digital FM modulator (82) digitally FM modulates the digital composite audio signal (79) into a digital FM modulated composite audio signal (83).

### BACKGROUND

The present disclosure relates to stereophonic audio encoders, and more particularly, to a BTSC encoding method with digital FM modulation.

### RELATED ART

In NTSC systems, the stereo audio signals are encoded with the Broadcast Television System Committee (BTSC) encoding. The standard for Multichannel Television Sound (MTS) was adopted in 1984 by the FCC for television broadcast of stereo audio. The BTSC encoder generates a composite audio signal consisting of a Left+Right (L+R) channel (main channel), a pilot tone, and an encoded and modulated Left-Right (L−R) channel (stereo channel). The main channel occupies the spectrum from 50 Hz to 14 kHz and, when modulated, has a 25 kHz peak deviation. The pilot tone is a single tone at approximately 15.734 kHz (exactly the horizontal line rate of the NTSC system). The stereo channel is a double sideband suppressed carrier signal centered at approximately 31.468 kHz (exactly twice the horizontal line rate of the NTSC system) with a bandwidth of 28 kHz. When modulated, the peak deviation of the stereo channel is 50 kHz. The composite audio signal is then FM modulated to produce a sound subcarrier. The RF modulator is responsive to the sound subcarrier and composite video signals and outputs TV signals on VHF and/or UHF channels.

BTSC system performance is affected not only by (i) the BTSC encoder itself and (ii) its implementation accuracy for complying with the BTSC standard, but also by (iii) a remainder of the system utilizing the BTSC encoder. For example, the processing of a composite audio signal prior to FM modulation, as well as, limitations of the analog FM modulator, may dramatically reduce the BTSC encoder performance.

FIG. 1 is a schematic block diagram view of a composite video and stereo audio system 10 having a traditional digital BTSC encoder 12 with an analog FM+RF modulator 14. As used herein, the annotation FM+RF modulator indicates a device which can perform both FM and RF modulation. System 10 further includes analog filters 16 and 18.

Analog filter 16 includes a left audio input 20 for receiving a left audio input signal and a right audio input 22 for receiving a right audio signal. Responsive to the left audio and right audio input signals, analog filter 16 outputs filtered left and right audio input signals on filter output signal lines 24 and 26, respectively. Analog filter 16 is an anti-alias filter and is used to filter out-of-band frequencies that may cause spurious outputs from an analog to digital converter (ADC) within the BTSC encoder 12.

BTSC encoder 12 includes a left audio input 24, a right audio input 26, and a composite video input. The left audio input 24 is adapted for receiving a left audio input signal, for example, a filtered L audio input signal. The right audio input 26 is adapted for receiving a right audio signal, for example, a filtered R audio input signal. Furthermore, the composite video input 28 is adapted for receiving a composite video signal or a video synchronizing signal. Responsive to the left audio, right audio and video input signals, the BTSC encoder 12 digitally encodes the left and right audio input signals into a composite audio signal and outputs the composite audio signal on a composite analog audio output 30.

Analog FM+RF modulator 14 includes a composite audio input 32 coupled to the composite audio output 30 of the BTSC encoder 12, for example, via analog filter 18, for receiving the composite audio output signal. Analog FM+RF modulator 14 further includes a composite video input 34 for receiving the composite video signal. As stated above, analog FM+RF modulator 14 performs both FM and RF modulation. Responsive to the input signals, analog FM+RF modulator 14 modulates the composite audio and video input signals into an RF modulated output signal and outputs the RF modulated output signal on an RF modulated output 36 of the analog FM+RF modulator. The FM+RF modulator output 36 is a TV signal for VHF and/or UHF channels. Analog filter 18 is a smoothing filter and filters any spurious signals outside the frequency band of the composite audio signal.

Performance of the BTSC encoder is defined in terms of S/(N+THD), i.e. the ratio of the signal (S) power to noise (N) power plus total harmonic distortion (THD), and stereophonic (channel) separation. Stereophonic separation can be defined as the ratio of the electrical signal caused in the right (or left) stereophonic channel to the electrical signal caused in the left (or right) stereophonic channel by the transmission of only a left (or right) signal. As previously mentioned above, performance is affected not only by the BTSC encoder itself and its implementation, but also by the rest of the system that incorporates the BTSC encoder. For example, there are several issues regarding the way in which the composite audio signal is processed and FM modulated.

With respect to a first issue, the channel separation is affected by amplitude and phase deviations of the composite audio signal from nominal values, described in the BTSC standard, which take place before the composite audio is modulated by the analog FM modulator. Amplitude variations can be caused, for example, by changes in power regulator precision, while amplitude/phase variations can be introduced by changes in analog components of a reconstruction filter (i.e., a smoothing filter following the DAC of the BTSC encoder). An amplitude variation of even a fraction of a decibel translates into a large degradation of the channel separation.

Table 1 lists examples of composite audio gain accuracies and stereo separations to illustrate the effect of amplitude variation on channel separation for an ideal BTSC encoder. An ideal channel separation would be desired to be better than minus forty decibels (−40 dB). In the first row of table 1, with a deviation of 1.1% from unit gain (equivalent to a 1.011 corresponding gain, further which is equivalent to 0.09502 dB corresponding gain), the channel separation is on the order of minus forty decibels (−40 dB). In the second row of table 1, with a deviation of 3.3% from unit gain (equivalent to a 1.033 corresponding gain, further which is equivalent to 0.28201 dB corresponding gain), the channel separation is on the order of minus thirty decibels (−30 dB). In the third row of table 1, with a deviation of 11.1% from unit gain (equivalent to a 1.111 corresponding gain, further which is equivalent to 0.91428 dB corresponding gain), the channel separation is on the order of minus twenty decibels (−20 dB). For comparison, TV studio quality for stereo separation is on the order of −30 to −35 dB.

TABLE 1

| Deviation from | Corresponding | Corresponding | Stereo |
|---|---|---|---|
| Unit Gain (%) | Gain | Gain (dB) | Separation (dB) |
| 1.1 | 1.011 | 0.09502 | −40 |
| 3.3 | 1.033 | 0.28201 | −30 |
| 11.1 | 1.111 | 0.91428 | −20 |

Taking note of the information of Table 1, these variations can be reduced by using components and power regulators with tighter tolerances, however doing so undesirably adds cost to a BTSC system. In addition, the process of adjusting the composite audio gain to achieve optimal performance of the BTSC system is costly and time consuming.

With respect to a second issue, analog FM modulators implemented in RF chips have linearity and bandwidth limitations. Accordingly, the linearity and bandwidth limitations reduce the performance of a corresponding BTSC encoder.

With respect to a third issue, the signal-to-noise ratio (S/N ratio) of the composite audio should be at least 84 dB to attain a prescribed quality similar to that of an analog BTSC encoder. This means that the conversion of the composite audio into the analog domain requires a DAC with a resolution of fourteen to sixteen (14-16) bits. A disadvantage of requiring such a DAC, however, is that a high-quality DAC adds additional cost to the overall system. Furthermore, circuit board layouts can introduce undesirable signal coupling and grounding issues. Such undesirable signal coupling and grounding issues can add noise to the DAC output, thereby degrading overall system performance.

Accordingly, there is a need for an improved method for overcoming the problems in the art as discussed above.

### BRIEF DESCRIPTION OF THE DRAWINGS

The present invention is illustrated by way of example and not limited by the accompanying figures, in which like references indicate similar elements, and in which:

FIG. 1 is a schematic block diagram view of a prior art composite video and stereo audio system having a BTSC encoder with an analog FM+RF modulator; and

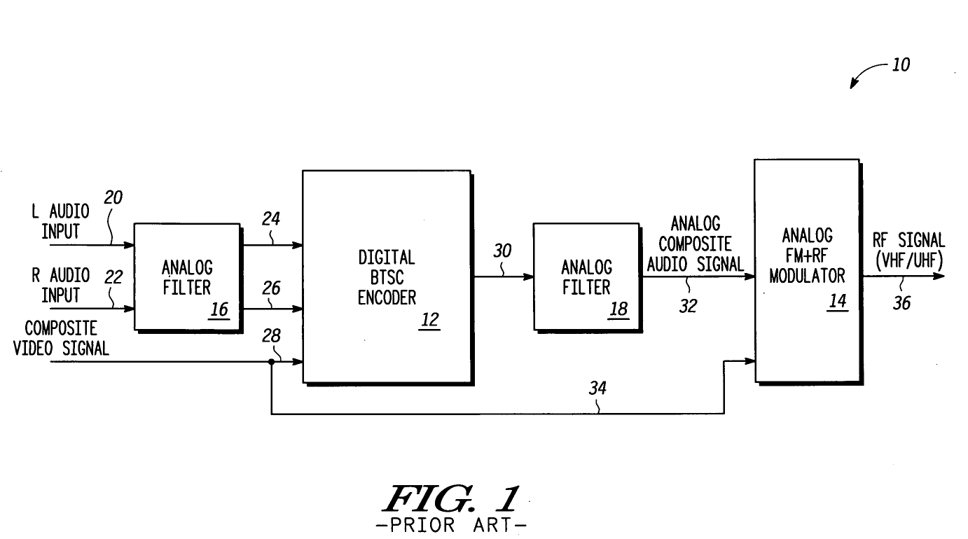

FIG. 2 is a schematic block diagram view of a composite video and stereo audio system having a digital BTSC encoder with a digital FM modulator feature according to one embodiment of the present disclosure.

The use of the same reference symbols in different drawings indicates similar or identical items. Skilled artisans will also appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION

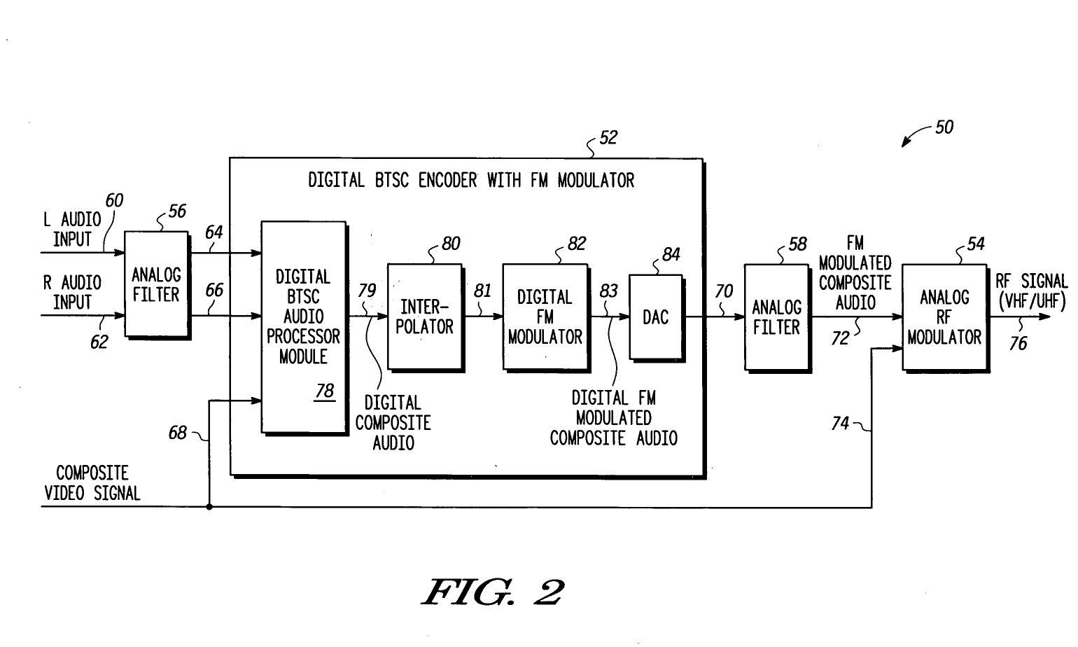

FIG. 2 is a schematic block diagram view of a composite video and stereo audio system 50 having a digital BTSC encoder 52 with a digital FM modulator feature according to one embodiment of the present disclosure. System 50 further includes analog filters 56 and 58. System 50 may be implemented as an integrated circuit implementation of the BTSC encoder with the digital FM modulator feature, analog RF modulator, and analog filters, according to the embodiments discussed herein.

Analog filter 56 includes a left audio input 60 for receiving a left audio input signal and a right audio input 62 for receiving a right audio signal. Responsive to the left audio and right audio input signals, analog filter 56 outputs filtered left and right audio input signals on filter output signal lines 64 and 66, respectively. Analog filter 56 is an anti-alias filter and is used to filter out-of-band frequencies that may cause spurious outputs from an analog to digital converter (ADC) within the digital BTSC encoder 52.

BTSC encoder 52 includes a left audio input 64, a right audio input 66, and a composite video input 68. The left audio input 64 is adapted for receiving a left audio input signal, for example, a filtered L audio input signal. The right audio input 66 is adapted for receiving a right audio signal, for example, a filtered R audio input signal. Furthermore, the composite video input 68 is adapted for receiving a composite video signal or a video synchronizing signal. Responsive to the left audio, right audio, and composite video or video synchronizing input signals, the BTSC encoder 52 digitally encodes the left and right audio input signals into a digital FM modulated composite audio signal. The digital BTSC encoder 52 also outputs the digital FM modulated composite audio signal as an analog FM modulated composite audio signal, after a digital to analog conversion, on composite analog audio output 70.

Analog RF modulator 54 includes an FM modulated composite audio input 72 coupled to the composite audio output 70 of the BTSC encoder 52, for example, via analog filter 58, for receiving the composite audio output signal. RF modulator 54 further includes a composite video input 74 for receiving the composite video signal. Responsive to the input signals, RF modulator 74 modulates the FM modulated composite audio input signal and the composite video input signal into an RF modulated output signal. RF modulator 74 outputs the RF modulated output signal on output 76. In particular, RF modulator 54 performs RF modulation of a combined signal of the FM modulated composite audio input signal and the composite video input signal into the RF modulated output signal. In one embodiment, the RF modulator output is a TV signal for VHF and/or UHF channels. In addition, analog filter 58 is a smoothing filter and filters any spurious signals outside the frequency band of the FM modulated composite audio signal.

Digital BTSC encoder 52 with a digital FM modulator feature according to one embodiment of the present disclosure will now be described in further detail. BTSC encoder 52 includes digital BTSC audio processor module 78, interpolator 80, digital FM modulator 82, and digital-to-analog converter (DAC) 84.

Digital BTSC audio processor module 78 comprises any suitable digital BTSC audio processor module having a left (L) audio input 64 adapted for receiving a left (L) audio signal and a right (R) audio input 66 adapted for receiving a right (R) audio signal. Module 78 further includes a video input 68 for receiving a composite video signal or a video synchronizing signal. Responsive to left audio, right audio, and composite video or synchronizing video input signals, the digital BTSC audio processor module 78 converts the input signals into a digital composite audio output signal on output 79, sampled at a baseband frequency. In one embodiment, the baseband frequency is 187.5 kHz.

Interpolator 80 comprises any suitable interpolator configured to provide for an upsampling of the composite audio signal output from digital BTSC audio processor module 78. In one embodiment in which the sampling rate of the composite audio output signal of the digital BTSC audio processor module 78 is insufficient for direct digital FM modulation, upsampling of the composite audio signal with use of interpolator 80 is necessary in preparation for an FM modulation, as will be discussed further herein. In the later case, prior to the FM modulation, the interpolator 80 upsamples the composite audio signal output to a new sampling frequency such that the FM modulated composite audio signal can be represented accurately, in compliance with the Nyquist sampling criterium. In one embodiment, the upsampling frequency is 24 MHz. In addition, interpolator 80 provides the upsampled composite audio signal on output 81.

Responsive to the upsampled digital composite audio signal, digital FM modulator 82 FM modulates the upsampled digital composite audio signal onto an FM carrier signal. In one embodiment, the frequency of the FM carrier signal is 4.5 MHz. Digital FM modulator comprises any suitable digital FM modulator design that can be implemented using known techniques. FM modulator 82 provides the digital FM modulated composite audio signal on output 83. In addition, either of the digital BTSC audio processor 78 or the digital FM modulator 82 can be configured, using suitable means, for adjusting a gain of the digital composite audio signal to achieve a prescribed range of frequency deviation as specified by the BTSC standard.

Responsive to the digital FM modulated composite audio signal, digital-to-analog converter (DAC) 84 converts the digital FM modulated composite audio signal into the analog domain, and outputs a corresponding analog FM modulated composite audio signal on output 70. DAC 84 comprises any suitable DAC for meeting the requirements of a particular digital BTSC encoder with FM modulator application. The DAC can be implemented using known techniques. In one embodiment, DAC 84 comprises a band pass sigma-delta DAC.

Accordingly, the present invention addresses the previously identified issues by using a digital BTSC encoder combined with a digital FM modulator. In other words, with the embodiments of the present disclosure, the composite audio is digitally FM modulated before performing the conversion of the digital composite audio signal into the analog domain.

In connection with the first issue discussed previously herein with respect to channel separation, by using a digital FM modulator as disclosed herein according to the present embodiments, the gain of the composite audio can be precisely adjusted in the digital domain in order to achieve the correct frequency deviation specified by the BTSC standard. The digital FM signal is then converted into the analog domain with the DAC. Component tolerances and voltage regulator precision can still change the amplitude of the analog FM modulated composite audio signal, but since the FM modulation is not sensitive to the signal amplitude, the channel separation is no longer affected by these variations. In addition, the FM output level of the analog FM signal needs only to satisfy the input requirements of the analog RF modulator.

In connection with the second issue discussed previously herein with respect to analog FM modulator linearity and bandwidth limitations, digital FM modulators have better performance than the analog ones especially in terms of bandwidth and linearity. For example, the digital FM modulator bandwidth extends down to DC and its linearity is very good over a wider range of frequency deviations. Accordingly, the digital FM modulator of the present embodiments allows improvement in the performance of the overall BTSC system.

In connection with the third issue discussed previously herein with respect to the S/N ratio, according to the embodiments of the present disclosure, as a result of producing a digital FM modulated composite audio signal prior to the DAC conversion, a more robust composite audio signal is produced which is less sensitive to noise, signal coupling, and grounding issues associated with or relating to a circuit board. According to one embodiment of the present disclosure, the conversion of the digital FM modulated composite audio signal requires only eleven to twelve (11-12) bit resolution versus fourteen to fifteen (14-15) bit resolution required for the conversion of the composite audio signal in traditional digital BTSC encoders. Such an advantage is due to the S/N improvement introduced by placing the digital FM modulator within the digital BTSC encoder and prior to the DAC. In fact, the S/N at the output of an FM demodulator can be expressed approximately as:
So/No=Si/Ni+10 log[3(ΔF/f_{M})²]+P
where Si/Ni is the S/N of the signal before demodulation, ΔF is the peak deviation, f_{M} is the highest baseband frequency and P is the pre-emphasis advantage (about 6.3 dB).

For the main channel of the BTSC encoder ΔF=25 kHz and f_{M}=14 kHz, thus an improvement of about 16 dB is achieved. If an 11-bit DAC is used for the conversion of the digital FM modulated composite audio, the Si/Ni is about 66 dB and the So/No is about 82 dB, equivalent to an improvement of approximately 3 bits. This means that, at a parity of BTSC system performance, the digital FM modulation approach requires only an 11-bit DAC instead of a 14-bit DAC necessary to convert the baseband digital composite audio of the traditional BTSC systems using analog FM modulators.

According to another embodiment, instead of using a classic DAC, the digital BTSC encoder with digital FM modulation can employ the use of a bandpass Sigma-Delta DAC. With the use of the bandpass Sigma-Delta DAC, various advantages can be obtained. For example, one advantage is that the converter is totally digital except for its output buffer. Accordingly, the digital BTSC encoder with digital FM modulation design is completely portable. In addition, a physical area required for implementing the bandpass Sigma-Delta DAC is smaller compared to an area required for implementing a traditional DAC. Furthermore, the digital BTSC encoder implementation using the Sigma-Delta DAC requires no voltage reference, as compared to the digital BTSC encoder implementation using the traditional DAC.

As discussed herein, the block diagram of the digital BTSC encoder combined with the digital FM modulator is shown in FIG. 2. In one embodiment, the sampling frequencies of the composite audio and of the FM signal are respectively 187.5 kHz and 24 MHz. The composite audio signal is first interpolated to 24 MHz and then FM modulated. Furthermore, in one embodiment, a 10th order bandpass Sigma-Delta DAC performs the conversion of the digital FM modulated composite audio signal into the analog domain. It should be noted that the parameters of the digital BTSC encoder with digital FM modulator may be different for different embodiments, according to the particular requirements of a given digital BTSC encoder design.

Further as discussed herein, in one embodiment, the digital BTSC audio processor outputs the digital composite audio signal at a first sampling frequency and the interpolator upsamples the composite audio signal to a second sampling frequency, wherein the second sampling frequency is different from the first sampling frequency. In such a case, the second sampling frequency is chosen to be sufficient to enable an accurate representation of the digital FM modulated composite audio signal in compliance with Nyquist sampling criterium.

As discussed herein, according to one embodiment, a method of digital BTSC encoding featuring integrated digital FM modulation includes: digitally encoding a left audio input signal and a right audio input signal into a digital composite audio signal; and responsive to the digital composite audio signal, digitally FM modulating the digital composite audio signal into a digital FM modulated composite audio signal. In another embodiment, the method further includes adjusting a gain of the digital composite audio signal to achieve a prescribed range of frequency deviation as specified by the BTSC standard, wherein the digital encoding is carried out by a digital BTSC encoder, the digital FM modulating is carried out by a digital FM modulator, and wherein the gain adjustment occurs within either the digital BTSC audio processor or the digital FM modulator. In another embodiment, the method further includes RF modulating the analog FM modulated composite audio signal and a composite video signal into an RF modulated signal.

Still further, according to another embodiment, the method includes: interpolating the digital composite audio signal by upsampling the digital composite audio signal into an upsampled digital composite audio signal, wherein digital FM modulation of the digital composite audio signal further comprises digitally FM modulating the upsampled digital composite audio signal. The digital FM modulating further comprises digital FM modulating the upsampled digital composite audio signal into the digital FM modulated composite audio signal. In one embodiment, the digital composite audio signal comprises a signal at a first sampling frequency. In addition, the interpolating upsamples the digital composite audio signal to a second sampling frequency, wherein the second sampling frequency is different from the first sampling frequency. Furthermore, the second sampling frequency is sufficient to enable an accurate representation of the digital FM modulated composite audio signal in compliance with Nyquist sampling criterium.

According to yet another embodiment, the method further includes converting the digital FM modulated composite audio signal into an analog FM modulated composite audio signal. Converting the digital FM modulated composite audio signal into an analog FM modulated composite audio signal includes using a Sigma-Delta digital-to-analog converter (DAC). Furthermore, the Sigma-Delta DAC can comprise a bandpass Sigma-Delta DAC.

In still another embodiment, the method further includes filtering the analog FM modulated composite audio signal and outputting a filtered analog FM modulated composite audio signal. The analog filter operates as a smoothing filter and filters any spurious signals outside of a frequency band of the analog FM modulated composite audio signal.

According to another embodiment, a method of digital BTSC encoding featuring integrated digital FM modulation includes: digitally encoding a left audio input signal and a right audio input signal into a digital composite audio signal; interpolating the digital composite audio signal by upsampling the digital composite audio signal into an upsampled digital composite audio signal; responsive to the upsampled digital composite audio signal, digitally FM modulating the upsampled digital composite audio signal into a digital FM modulated composite audio signal; and converting the digital FM modulated composite audio signal into an analog FM modulated composite audio signal.

In yet another embodiment, the digital composite audio signal comprises a signal at a first sampling frequency. The step of interpolating upsamples the digital composite audio signal to a second sampling frequency, wherein the second sampling frequency is different from the first sampling frequency. In addition, the second sampling frequency is sufficient to enable an accurate representation of the digital FM modulated composite audio signal in compliance with Nyquist sampling criterium. In yet another embodiment, the method further includes RF modulating the analog FM modulated composite audio signal and a composite video signal into an RF modulated signal.

According to still another embodiment, a method of implementing digital BTSC encoding with integrated digital FM modulation on an integrated circuit comprises: digitally encoding a left audio input signal and a right audio input signal into a digital composite audio signal via a digital BTSC audio processor; and responsive to the digital composite audio signal, digitally FM modulating the digital composite audio signal into a digital FM modulated composite audio signal via a digital FM modulator.

In the foregoing specification, the disclosure has been described with reference to the various embodiments. However, one of ordinary skill in the art appreciates that various modifications and changes can be made without departing from the scope of the present embodiments as set forth in the claims below. Accordingly, the specification and figures are to be regarded in an illustrative rather than a restrictive sense, and all such modifications are intended to be included within the scope of the present embodiments. For example, as discussed herein, the digital composite audio signal is FM modulated to produce a sound subcarrier. Accordingly, the digital FM modulator could be defined as an FM sound subcarrier modulator and the phrase “FM modulator” is meant to include an FM sound subcarrier modulator. In addition, the embodiments of the present disclosure further include a digital BTSC encoder with digital FM modulation that comprises a single-chip BTSC encoder. The embodiments of the present disclosure further comprise an integrated circuit that includes the digital BTSC encoder with integrated digital FM modulation as discussed herein.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the term “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method of digital BTSC (Broadcast Television Systems Committee) encoding featuring integrated digital FM modulation comprising:
digitally encoding a left audio input signal and a right audio input signal into a digital composite audio signal; and
responsive to the digital composite audio signal, digitally FM modulating the digital composite audio signal into a digital FM modulated composite audio signal.

2. The method of claim 1, further comprising:
adjusting a gain of the digital composite audio signal to achieve a prescribed range of frequency deviation as specified by the BTSC standard, wherein the digital encoding is carried out by a digital BTSC encoder, the digital FM modulating is carried out by a digital FM modulator, and wherein the gain adjustment occurs within either the digital BTSC audio processor or the digital FM modulator.

3. The method of claim 1, further comprising:
interpolating the digital composite audio signal by upsampling the digital composite audio signal into an upsampled digital composite audio signal, wherein digital FM modulation of the digital composite audio signal further comprises digitally FM modulating the upsampled digital composite audio signal.

4. The method of claim 3, wherein further the digital FM modulating further comprises digital FM modulating the upsampled digital composite audio signal into the digital FM modulated composite audio signal.

5. The method of claim 3, wherein the digital composite audio signal comprises a signal at a first sampling frequency, further wherein the interpolating upsamples the digital composite audio signal to a second sampling frequency, wherein the second sampling frequency is different from the first sampling frequency, and wherein the second sampling frequency is sufficient to enable an accurate representation of the digital FM modulated composite audio signal in compliance with Nyquist sampling criterium.

6. The method of claim 1, further comprising:
converting the digital FM modulated composite audio signal into an analog FM modulated composite audio signal.

7. The method of claim 6, wherein converting the digital FM modulated composite audio signal into an analog FM modulated composite audio signal includes using a Sigma-Delta digital-to-analog converter (DAC).

8. The method of claim 7, wherein the Sigma-Delta DAC further comprises a bandpass Sigma-Delta DAC.

9. The method of claim 6, further comprising:
filtering the analog FM modulated composite audio signal and outputting a filtered analog FM modulated composite audio signal.

10. The method of claim 9, wherein the analog filter operates as a smoothing filter and filters any spurious signals outside of a frequency band of the analog FM modulated composite audio signal.

11. The method of claim 6, further comprising:
RF modulating the analog FM modulated composite audio signal and a composite video signal into an RF modulated signal.

12. The method of claim 6, wherein digitally encoding the left and right audio input signals is carried out by a digital BTSC audio processor having left and right audio inputs for receiving the left and right audio input signals, the method further comprising:
filtering the left audio and right audio input signals with a first analog filter and outputting filtered left and right audio input signals to corresponding inputs of the digital BTSC audio processor;
filtering the analog FM modulated composite audio signal with a second analog filter and outputting a filtered analog FM modulated composite audio signal; and
RF modulating the filtered analog FM modulated composite audio signal and a composite video signal into an RF modulated signal.

13. The method of claim 12, wherein the first analog filter comprises an anti-aliasing filter for filtering out-of-band frequencies that may cause spurious outputs from an analog-to-digital converter (ADC) disposed within the digital BTSC audio processor.

14. The method of claim 12, wherein the second analog filter comprises a smoothing filter for filtering any spurious signals outside a frequency band of the analog FM modulated composite audio signal.

15. The method of claim 1, wherein the digital BTSC encoding further comprises carrying out the encoding within a single-chip digital BTSC encoder.

16. A method of digital BTSC (Broadcast Television Systems Committee) encoding featuring integrated digital FM modulation comprising:
digitally encoding a left audio input signal and a right audio input signal into a digital composite audio signal;
interpolating the digital composite audio signal by upsampling the digital composite audio signal into an upsampled digital composite audio signal;
responsive to the upsampled digital composite audio signal, digitally FM modulating the upsampled digital composite audio signal into a digital FM modulated composite audio signal; and
converting the digital FM modulated composite audio signal into an analog FM modulated composite audio signal.

17. The method of claim 16, wherein the digital composite audio signal comprises a signal at a first sampling frequency, further wherein the interpolating upsamples the digital composite audio signal to a second sampling frequency, wherein the second sampling frequency is different from the first sampling frequency, and wherein the second sampling frequency is sufficient to enable an accurate representation of the digital FM modulated composite audio signal in compliance with Nyquist sampling criterium.

18. The method of claim 16, further comprising:
RF modulating the analog FM modulated composite audio signal and a composite video signal into an RF modulated signal.

19. The method of claim 16, wherein digitally encoding the left and right audio input signals is carried out by a digital BTSC audio processor having left and right audio inputs for receiving the left and right audio input signals, the method further comprising:
filtering the left audio and right audio input signals with a first analog filter and for outputting filtered left and right audio input signals to corresponding inputs of the digital BTSC audio processor;
filtering the analog FM modulated composite audio signal with a second analog filter and for outputting a filtered analog FM modulated composite audio signal; and
RF modulating the filtered analog FM modulated composite audio signal and a composite video signal into an RF modulated signal.

20. A method of implementing digital BTSC (Broadcast Television Systems Committee) encoding with integrated digital FM modulation on an integrated circuit, comprising:
digitally encoding a left audio input signal and a right audio input signal into a digital composite audio signal via a digital BTSC audio processor; and
responsive to the digital composite audio signal, digitally FM modulating the digital composite audio signal into a digital FM modulated composite audio signal via a digital FM modulator.
